(19) United States
(12) Patent Application Publication
(10) Pub. No.: US 2001/0013086 A1
(43) Pub. Date: Aug. 9, 2001

(54) Multiprocessor system and data transmitting method

(76) Inventors: Tetsuo Sugita, Hadano (JP); Naonobu Sukegawa, Inagi (JP); Yuichi Saigan, Hadano (JP)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/736,884

(22) Filed: Dec. 13, 2000

(30) Foreign Application Priority Data
Dec. 13, 1999 (JP) 11-353412

(51) Int. Cl. G06F 13/00

(52) U.S. Cl. 711/119

(57) ABSTRACT

Plural instruction processors define part of a main memory as a broadcast area and each have a broadcast area cache for the broadcast area only. An exclusive line which interconnects the broadcast area caches is provided; in order to reflect the result of data updating by a store instruction issued by an instruction processor for the broadcast area, the store instruction is automatically sent to all broadcast area caches for data updating. The other data-receiving instruction processors receive the data by means of a load instruction.

### CROSS-REFERENCES TO RELATED APPLICATIONS

This application claims priority from Japanese Patent Application Reference No. P11-353412, filed Dec. 13, 1999.

### BACKGROUND OF THE INVENTION

The present invention relates to multiprocessor systems and particularly to multiprocessor systems which efficiently perform data transfer between instruction processors constituting the multiprocessor system.

Description of Related Art

A multiprocessor system, a computer system composed of plural instruction processors, performs processing by data transfer between instruction processors. In a conventional multiprocessor system, data transfer between instruction processors is carried out as follows: a data-sending instruction processor writes the data to be sent in the main memory (main storage) or data transmission resource and a data-receiving instruction processor accesses the main memory or data transmission resource to read the data written by the data-sending processor.

### SUMMARY OF THE INVENTION

The above-mentioned method for data transfer between instruction processors in a conventional multiprocessor system has problems as discussed below.

The data-receiving instruction processor must wait for the data written by the data-sending instruction processor to be ready to be read, in order to read the data. In the method where data is transmitted or received through the main memory, synchronization between the instruction processors is necessary in order to ensure that the data-sending instruction processor has written the data in the main memory. This inter-processor synchronization takes place after not only the completion of writing the data to be sent in the main memory but also the completion of all preceding operations to be done before the synchronization. Thus, the conventional method poses a problem related to time of waiting for the completion of preceding operations which would be unnecessary if there should be no such operations: the data-receiving instruction processor can read the data to be received from the main memory, only after both the preceding operations and synchronization have been completed.

The method where data is transmitted or received through a special resource for data transmission/reception has another problem: since such a special resource is generally small in capacity and is not covered by data caches in the instruction processors, a latency for access to the special resource is required each time data is read.

Besides, in this method, when an operation underway is interrupted to begin another operation, the data transmission/reception resource must be freed for the new operation; operations for the escape and subsequent recovery of existing data inside the special resource in the transition from one operation to another are added to overhead for transition to another operation as mentioned above.

The present invention has been made in view of the above circumstances and has an object to overcome the aforementioned problems of the prior art and to provide a multiprocessor system which provides higher speed in data transfer between instruction processors, thereby improving the overall performance of the system.

According to an aspect of the present invention, the above-said object is achieved by a multiprocessor system having plural instruction processors and a first cache memory for storage of data in main memory, in which a function to designate an arbitrary range of consecutive addresses in the main memory as a special region and a dedicated second cache memory to register only the data in the special region in the main memory are provided.

According to another aspect of the present invention, the object is achieved by a multiprocessor system in which each instruction processor in the system has said first and second cache memories, the system having means to control coherency between said first cache memories, and means to, when the data in the second cache memory of an instruction processor is subjected to updating by another instruction processor, perform updating the previously registered data in said second cache memory without invalidating it.

Each of the instruction processors which constitute a multiprocessor according to the present invention can arbitrarily define part of the main memory as a broadcast area, and data transmission or reception Is carried out using a broadcast area cache for data in the broadcast area. A data-sending instruction processor sends the relevant data to the main memory by designating a main memory address in the broadcast area, and at the same time sends the data to the broadcast area cache corresponding to the instruction processor to receive the data. If the address for the data to be sent/received is contained in the broadcast area cache corresponding to the data-receiving instruction processor, the data-receiving instruction processor can access the data in the broadcast area cache in the same manner as for access to the main memory, so the data-receiving instruction processor can receive the data from the broadcast area cache and hold it in its data cache.

As the data sent by the data-sending instruction processor reflects the data in the broadcast area cache, updating of the broadcast area cache is detected in synchronization between the instruction processors, which guarantees a shorter process than the conventional process in which completion of all preceding operations is necessary before completion of synchronization between the instruction processors.

According to another aspect of the present invention, the overhead for synchronization between the instruction processors can be reduced due to the operational sequence, data transfer between the instruction processors can be done in a shorter time than the main memory access latency without the disadvantage that the use of the special resource hinders data registration in the data cache.

If the address for the data to be sent/received is not contained in the broadcast area cache corresponding to the data-receiving instruction processor, the data to be received is sent and received through the main memory. In the present invention, the speed of data transfer between the instruction processors can be increased by caching the data for the relevant address into the broadcast area cache beforehand.

Since the broadcast area is in the main memory, if an operation underway is interrupted to begin another operation, the data stored in the broadcast area need not be escaped for the new operation, which reduces the overhead for transition to another operation.

### BRIEF DESCRIPTION OF THE DRAWINGS

Preferred embodiments of the present invention will be described in detail based on the followings, wherein:

FIG. 1 is a block diagram showing a multiprocessor system according to the present invention; and

FIG. 2 is a block diagram showing the control circuit for a broadcast area cache.

### DESCRIPTION OF THE SPECIFIC EMBODIMENTS

One embodiment of a multiprocessor system according to the present invention is described in detail next referring to the drawings.

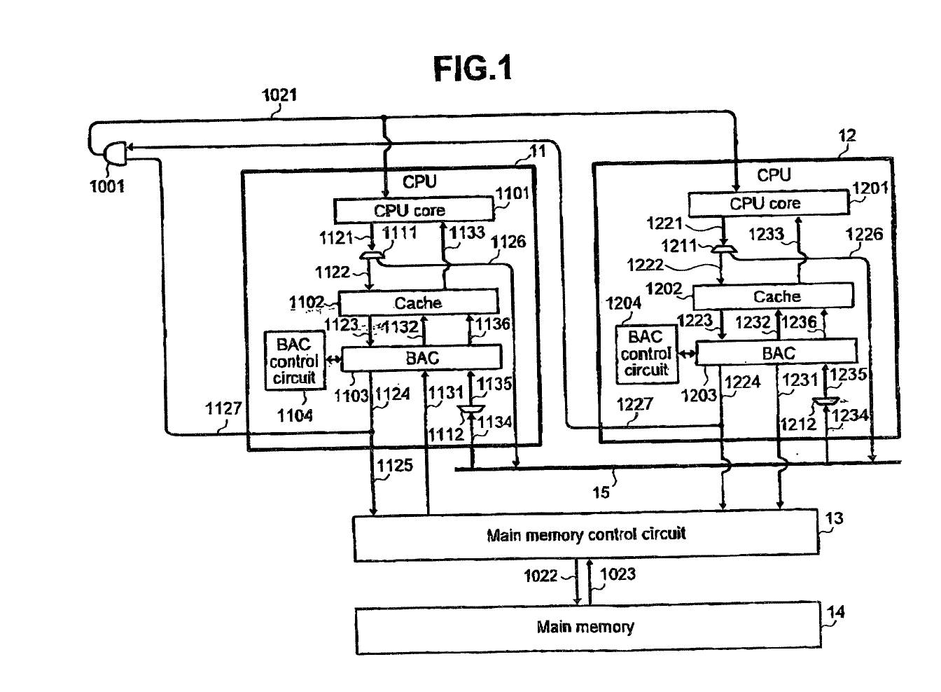

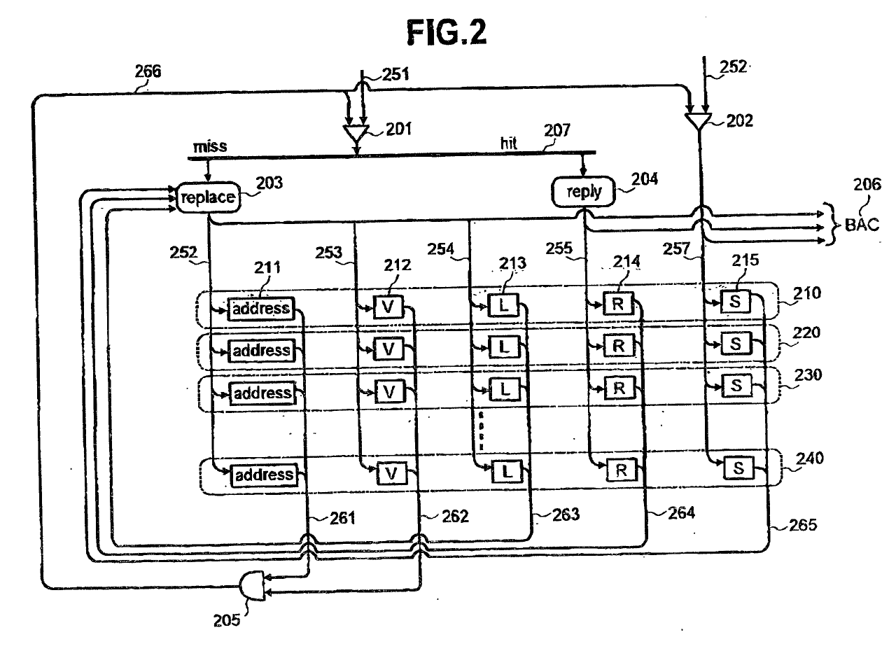

FIG. 1 is a block diagram showing a multiprocessor system according to the present invention while FIG. 2 is a block diagram showing the control circuit for a broadcast area cache. In FIGS. 1 and 2, reference numerals 11 and 12 represent instruction processors, 13 a main memory control circuit, 14 a main memory, 15 an exclusive line to interconnect broadcast area caches, 201 an address comparator for load instructions, 202 an address comparator for store instructions, 203 a circuit to select the line to be replaced, 204 a circuit to decide whether it is possible to start reply, 1001 a waiting circuit for inter-processor synchronization, 1101 and 1201 CPU cores, 1102 and 1202 caches, 1103 and 1203 broadcast area caches, 1104 and 1204 broadcast area cache control circuits, and 1111, 1112, 1211 and 1212 address decoders.

As seen in FIG. 1 which indicates the structure of a multiprocessor system as an embodiment of the present invention, the present invention is applied to a shared main memory type multiprocessor system comprising plural instruction processors 11 and 12, a main memory control circuit 13 and a main memory 14. The details of the embodiment are discussed below.

The instruction processor 11 comprises the following: a CPU core 1101, a data cache 1102 equivalent to that of a typical processor as a first cache, a broadcast area cache 1103 as a second cache provided according to the present invention, a broadcast area cache control circuit 1104 and address decoders 1111 and 1112, all of which are interconnected. The instruction processor 12 has the same structure as the instruction processor 11.

The broadcast area cache 1103 caches only data for addresses in the broadcast area set in the main memory 14. As a broadcast area, an arbitrary range of consecutive addresses in the main memory can be specified. Provided between the instruction processors 11 and 12 is an exclusive bus 15 which interconnects the broadcast area caches 1103 and 1203, as a broadcasting means for transmitting data to all instruction processors. In addition to the instruction processors 11 and 12, main memory control circuit 13, main memory 14 and exclusive bus 15 for the broadcast area caches, the multiprocessor system shown here comprises a waiting circuit for inter-processor synchronization 1001 as a means for synchronization.

The main memory control circuit 13, which controls data transfer between the main memory 14 and instruction processor 11 or 12, can use a bus or switch as a means to connect the main memory 14 and instruction processor 11 or 12. In the example shown in FIG. 1, there are two instruction processors; however, more instruction processors may be provided.

There are many types of cache. It is assumed here that the caches 1102 and 1202 are of the store-through type. The caches 1102 and 1202 delete a cache line according to a store instruction issued by another instruction processor. The broadcast area caches 1103 and 1203 are updated by a store instruction issued by another instruction processor. The broadcast area caches 1103 and 1203 have two types of periods: a period during which they accept new registration and one during which they don't.

Let's assume that the CPU core 1101 of the instruction processor 11 issues a load instruction for the broadcast area in the main memory 14. If the relevant address is neither contained in the cache 1102 nor in the broadcast area cache 1103, and new registration into the broadcast area cache 1103 is impossible, the system shown here runs in the following sequence.

The CPU core 1101 issues a load instruction. This load instruction reaches the cache 1102 via the path 1121. The cache 1102 detects the non-existence of the relevant address in the cache 1102 and starts cache line block transfer from the main memory. The “block transfer” instruction passes through the path 1123 and arrives at the broadcast area cache 1103. Since the relevant address does not exist in the broadcast area cache 1103 as well, the control circuit 1104 concludes that new registration is impossible and at the same time issues a block transfer instruction via the path 1125. This block transfer instruction is passed through the main memory control circuit 13 and path 1022 and sent to the main memory 14, from which the data in the line containing the relevant address is read and led through the path 1023, main memory control circuit 13 and path 1131 to the broadcast area cache 1103.

As the broadcast area cache 1103 predicts that it is impossible to register data, it is not ready for registration and thus does not accept any new registration; the data as the result of the block transfer is sent through the path 1132 to the cache 1102. The cache 1102 registers the result of this block transfer and sends out the data for the relevant address for the first load instruction through the path 1133 to the CPU core 1101.

Upon completion of the above-mentioned series of operations, the line containing the relevant address for the first issued load instruction is registered in the cache 1102.

Next, assuming that the CPU core 1101 of the instruction processor 11 issues a load instruction for the broadcast area in the main memory 14, and that the relevant address is neither contained in the cache 1102 nor in the broadcast area cache 1103, as in the above case, but that new registration into the broadcast area cache 1103 is possible, the system shown here runs in the following sequence.

The CPU core 1101 issues a load instruction. This load instruction reaches the cache 1102 via the path 1121. The cache 1102 detects the non-existence of the relevant address in the cache 1102 and starts cache line block transfer from the main memory. The block transfer instruction passes through the path 1123 and arrives at the broadcast area cache 1103. Since the relevant address does not exist in the broadcast area cache 1103 as well, the control circuit 1104, which concludes that new registration is possible, prepares for new registration and at the same time issues a block transfer instruction via the path 1125. This block transfer instruction is passed through the main memory control circuit 13 and path 1022 and sent to the main memory 14, from which the data in the line containing the relevant address is read and led through the path 1023, main memory control circuit 13 and path 1131 to the broadcast area cache 1103.

As the broadcast area cache 1103 is prepared for registration, it registers the data in that line, and at the same time sands the data as the result of the block transfer through the path 1132 to the cache 1102. The cache 1102 registers the result of this block transfer and sends out the data for the relevant address for the first load instruction through the path 1133 to the CPU core 1101.

Upon completion of the above-mentioned series of operations, the line containing the relevant address for the first issued load instruction is registered in the cache 1102 and broadcast area cache 1103.

Next, similarly, assuming that the CPU core 1101 of the instruction processor 11 issues a load instruction for the broadcast area in the main memory 14, and that the relevant address is not contained in the cache 1102 but is contained in the broadcast area cache 1103, the system shown here runs in the following sequence.

The CPU core 1101 issues a load instruction. This load instruction passes through the path 1121, and after being judged by the address decoder 1111 to be directed to the broadcast area, reaches the cache 1102 via the path 1122. The cache 1102 detects the non-existence of the relevant address in the cache 1102 and starts cache line block transfer from the main memory. The “block transfer” instruction passes through the path 1123 and arrives at the broadcast area cache 1103. Since the relevant address exists in the broadcast area cache 1103, the control circuit 1104, which detects that the broadcast area cache 1103 has been hit, sends the relevant line to the path 1132 to send the data as the result of the block transfer to the cache 1102. The cache 1102 registers the result of this block transfer and sends out the data for the relevant address for the first load instruction through the path 1133 to the CPU core 1101.

Upon completion of the above-mentioned series of operations, the line containing the relevant address for the first issued load instruction is registered in the cache 1102 and broadcast area cache 1103.

Next, similarly, assuming that the CPU core 1101 of the instruction processor 11 issues a load instruction for the broadcast area in the main memory 14, and that the relevant address is contained in the cache 1102, the system shown here runs in the following sequence.

The CPU core 1101 issues a load instruction. This load instruction passes through the path 1121, and after being judged by the address decoder 1111 to be directed to the broadcast area, reaches the cache 1102 via the path 1122. The cache 1102 detects the existence of the relevant address in the cache 1102 and sends out the data for the relevant address for the first load instruction through the path 1133 to the CPU core 1101.

Upon completion of the above-mentioned series of operations, the line containing the relevant address for the first issued load instruction is registered in the cache 1102. Here it does not matter whether the line containing the relevant address is contained in the broadcast area cache 1103.

Next, assuming that the CPU core 1101 of the instruction processor 11 issues a store instruction for the broadcast area in the main memory 14, and that the relevant address is contained in neither the cache 1102 of the instruction processor 11 nor the cache 1202 of the instruction processor 12 and also in neither the broadcast area cache 1103 of the instruction processor 11 nor the broadcast area cache 1203 of the instruction processors 12, the system shown here runs in the following sequence.

The CPU core 1101 issues a store instruction. This store instruction passes through the path 1121, and is judged by the address decoder 1111 to be directed to the broadcast area. After making this judgment, the address decoder 1111 sends this store instruction to the paths 1122 and 1126. The store instruction sent to the path 1122 reaches the cache 1102. Since the line containing the relevant address is not registered in the cache 1102, nothing occurs. Then, this store instruction passes through the path 1123 and reaches the broadcast area cache 1103. The store instruction coming from the path 1123 causes nothing in the broadcast area cache 1103. This store instruction further passes through the paths 1124 and 1125, main memory control circuit 13 and path 1022 before arriving at the main memory 14 to update the data in the main memory 14.

On the other hand, the store instruction sent to the path 1126 passes through the path 15 interconnecting all broadcast area caches before reaching all instruction processors 11 and 12. The store instruction which has entered the instruction processor 11 which issues it is led through the path 1134 to the decoder 1112, which detects that it is a store instruction directed to the broadcast area. Then, this store instruction passes through the path 1135 and reaches the broadcast area cache 1103; the control circuit 1104 detects that the relevant address does not exist in the broadcast area cache 1103. In this case, the broadcast area cache 1103 is not updated.

The store instruction which has entered the instruction processor 12, an instruction processor other than the instruction processor 11 which issues the store instruction, is led through the path 1234 to the decoder 1212, which detects that it is a store instruction for the broadcast area. Then this store instruction passes through the path 1235 and reaches the broadcast area cache 1203; the control circuit 1204 detects that the relevant address does not exist in the broadcast area cache 1203. In this case, the broadcast area cache 1203 is not updated. Further, this store instruction passes through the path 1236 and reaches the cache 1202. The cache 1202 detects that there is no line containing the relevant address in the cache 1202 and thus the cache 1202 is not updated.

Upon completion of the above-mentioned series of operations, the line containing the relevant address for the first issued store instruction is not registered in the caches 1102 and 1202 and the broadcast area caches 1103 and 1203.

Next, assuming that the CPU core 1101 of the instruction processor 11 issues a store instruction for the broadcast area, and that the relevant address is contained not in the cache 1102 of the instruction processor 11 as the store instruction issuer but in the broadcast area cache 1103 of the issuer instruction processor 11, the system shown here runs in the following sequence.

The CPU core 1101 issues a store instruction. This store instruction passes through the path 1121, and is judged by the address decoder 1111 to be directed to the broadcast area. After knowing that it is a store instruction for the broadcast area, the address decoder 1111 sends this store instruction to the paths 1122 and 1126. The store instruction sent to the path 1122 reaches the cache 1102. Since the line containing the relevant address is not registered in the cache 1102, nothing occurs. Then, this store instruction passes through the path 1123 and reaches the broadcast area cache 1103. The store instruction coming from the path 1123 causes nothing in the broadcast area cache 1103. This store instruction further passes through the paths 1124 and 1125, main memory control circuit 13 and path 1022 before arriving at the main memory 14 to update the data in the main memory 14.

On the other hand, the store instruction sent to the path 1126 passes through the path 15 interconnecting all broadcast area caches before reaching all instruction processors 11 and 12. The store instruction which has entered the instruction processor 11 as the issuer of the store instruction is led through the path 1134 to the decoder 1112, which detects that it is a store instruction for the broadcast area; then it passes through the path 1135 and reaches the broadcast area cache 1103: the control circuit 1104 detects that the relevant address does exist in the broadcast area cache 1103, so the broadcast area cache 1103 is updated.

The store instruction which has entered the instruction processor 12, an instruction processor other than the instruction processor 11 as the issuer of the store instruction, is led through the path 1234 to the decoder 1212, which detects that it is a store instruction for the broadcast area. Then this store instruction passes through the path 1235 and reaches the broadcast area cache 1203; the control circuit 1204 detects that the relevant address does not exist in the broadcast area cache 1203. In this case, the broadcast area cache 1203 is not updated. Further, this store instruction passes through the path 1236 and reaches the cache 1202. The cache 1202 detects that there is no line containing the relevant address in the cache 1202 and thus the cache 1202 is not updated.

Upon completion of the above-mentioned series of operations, the line containing the relevant address for the first issued store instruction is registered in the broadcast area cache 1103 as updated but not in the cache 1102.

Next, assuming that the CPU core 1101 of the instruction processor 11 issues a store instruction for the broadcast area, and that the relevant address is contained in the cache 1102 of the instruction processor 11 as the issuer of the store instruction but not in the broadcast area cache 1103 of the issuer instruction processor 11, the system shown here runs in the following sequence.

The CPU core 1101 issues a store instruction. This store instruction passes through the path 1121, and is judged by the address decoder 1111 to be directed to the broadcast area. After knowing that it is a store instruction for the broadcast area, the address decoder 1111 sends this store instruction to the paths 1122 and 1126. The store instruction sent to the path 1122 reaches the cache 1102. Since the line containing the relevant address is registered in the cache 1102, the cache 1102 updates the line. Then, this store instruction passes through the path 1123 and reaches the broadcast area cache 1103. The store instruction coming from the path 1123 causes nothing in the broadcast area cache 1103. This store instruction further passes through the paths 1124 and 1125, main memory control circuit 13 and path 1022 before arriving at the main memory 14 to update the data in the main memory 14.

On the other hand, the store instruction sent to the path 1126 passes through the path 15 interconnecting all broadcast area caches before reaching all instruction processors 11 and 12. The store instruction which has entered the instruction processor 11 as the issuer of the store instruction is led through the path 1134 to the decoder 1112, which detects that it is a store instruction for the broadcast area; then it passes through the path 1135 and reaches the broadcast area cache 1103. The control circuit 1104 detects that the relevant address does not exist in the broadcast area cache 1103, so the broadcast area cache 1103 is not updated.

The store instruction which has entered the instruction processor 12, an instruction processor other than the instruction processor 11 as the issuer of the store instruction, is led through the path 1234 to the decoder 1212, which detects that it is a store instruction for the broadcast area. Then this store instruction passes through the path 1235 and reaches the broadcast area cache 1203; the control circuit 1204 detects that the relevant address does not exist in the broadcast area cache 1203. In this case, the broadcast area cache 1203 is not updated. Further, this store instruction passes through the path 1236 and reaches the cache 1202. The cache 1202 detects that there is no line containing the relevant address in the cache 1202; therefore the cache 1202 is not updated.

Upon completion of the above-mentioned series of operations, the line containing the relevant address for the first issued store instruction is not registered in the cache 1102 and the broadcast area cache 1103.

Next, assuming that the CPU core 1101 of the instruction processor 11 issues a store instruction for the broadcast area, and that the relevant address is contained in the cache 1102 of the instruction processor 11 as the issuer of the store instruction and the broadcast area cache 1103 of the issuer instruction processor 11, the system shown here runs in the following sequence.

The CPU core 1101 issues a store instruction. This store instruction passes through the path 1121, and is judged by the address decoder 1111 to be directed to the broadcast area. After knowing that it is a store instruction for the broadcast area, the address decoder 1111 sends this store instruction to the paths 1122 and 1126. The store instruction sent to the path 1122 reaches the cache 1102. Since the line containing the relevant address is registered in the cache 1102, the cache 1102 updates the line. Then, this store instruction passes through the path 1123 and reaches the broadcast area cache 1103. The store instruction coming from the path 1123 causes nothing in the broadcast area cache 1103. The store instruction further passes through the paths 1124 and 1125, main memory control circuit 13 and path 1022 before arriving at the main memory 14 to update the data in the main memory 14.

On the other hand, the store instruction sent to the path 1126 passes through the path 15 interconnecting all broadcast area caches before reaching all instruction processors 11 and 12. The store instruction which has entered the instruction processor 11 as the issuer of the store instruction is led through the path 1134 to the decoder 1112, which detects that it is a store instruction for the broadcast area; then it passes through the path 1135 and reaches the broadcast area cache 1103. The control circuit 1104 detects that the relevant address does exist in the broadcast area cache 1103, so the data for the relevant address in the broadcast area cache 1103 is updated.

The store instruction which has entered the instruction processor 12, an instruction processor other than the instruction processor 11 as the issuer of the store instruction, is led through the path 1234 to the decoder 1212, which detects that it is a store instruction for the broadcast area. Then the store instruction passes through the path 1235 and reaches the broadcast area cache 1203; the control circuit 1204 detects that the relevant address does not exist in the broadcast area cache 1203. In this case, the broadcast area cache 1203 is not updated. Further, the store instruction passes through the path 1236 and reaches the cache 1202. The cache 1202 detects that there is no line containing the relevant address in the cache 1202, so the cache 1202 is not updated.

Upon completion of the above-mentioned series of operations, the line containing the relevant address for the first issued store instruction is registered in the broadcast area cache 1103 as updated, but not in the cache 1102.

Next, assuming that the CPU core 1101 of the instruction processor 11 issues a store instruction for the broadcast area, and that the relevant address is not contained in the cache 1202 of the instruction processor 12, a non-issuer instruction processor, but is contained in the broadcast area cache 1203 of the non-issuer instruction processor 12, the system shown here runs in the following sequence.

The CPU core 1101 issues a store instruction. This store instruction passes through the path 1121, and is judged by the address decoder 1111 to be directed to the broadcast area. After knowing that it is a store instruction for the broadcast area, the address decoder 1111 sends this store instruction to the paths 1122 and 1126. The store instruction sent to the path 1122 reaches the cache 1102. Since the line containing the relevant address is not registered in the cache 1102, nothing occurs in the cache 1102. Then, the store instruction passes through the path 1123 and reaches the broadcast area cache 1103. The store instruction coming from the path 1123 causes nothing in the broadcast area cache 1103. The store instruction further passes through the paths 1124 and 1125, main memory control circuit 13 and path 1022 before arriving at the main memory 14 to update the data in the main memory 14.

On the other hand, the store instruction sent to the path 1126 passes through the path 15 interconnecting all broadcast area caches before reaching all, instruction processors 11 and 12. The store instruction which has entered the instruction processor 11 as the issuer of the store instruction is led through the path 1134 to the decoder 1112, which detects that it is a store instruction for the broadcast area; then it passes through the path 1135 and reaches the broadcast area cache 1103. The control circuit 1104 detects that the relevant address does not exist in the broadcast area cache 1103, so the broadcast area cache 1103 is not updated.

The store instruction which has entered the instruction processor 12, an instruction processor other than the instruction processor 11 as the issuer of the store instruction, is led through the path 1234 to the decoder 1212, which detects that it is a store instruction for the broadcast area. Then this store instruction passes through the path 1235 and reaches the broadcast area cache 1203; the control circuit 1204 detects that the relevant address does exist in the broadcast area cache 1203. The control circuit 1204 updates the data for the relevant address in the broadcast area cache 1203. Further, the store instruction passes through the path 1236 and reaches the cache 1202. The cache 1202 detects that there is no line containing the relevant address in the cache 1202, so the cache 1202 is not updated.

Upon completion of the above-mentioned series of operations, the line containing the relevant address for the first issued store instruction is registered in the broadcast area cache 1203 as updated, but not in the cache 1102.

Next, assuming that the CPU core 1101 of the instruction processor 11 issues a store instruction for the broadcast area, and that the relevant address is contained in the cache 1202 of the instruction processor 12 as a non-issuer but not in the broadcast area cache 1203 of the non-issuer instruction processor 12, the system shown here runs in the following sequence.

The CPU core 1101 issues a store instruction. This store instruction passes through the path 1121, and is judged by the address decoder 1111 to be directed to the broadcast area. After knowing that it is a store instruction for the broadcast area, the address decoder 1111 sends this store instruction to the paths 1122 and 1126. The store instruction sent to the path 1122 reaches the cache 1102. Since the line containing the relevant address is not registered in the cache 1102, nothing occurs in the cache 1102. Then, this store instruction passes through the path 1123 and reaches the broadcast area cache 1103. The store instruction coming from the path 1123 causes nothing in the broadcast area cache 1103. The store instruction further passes through the paths 1124 and 1125, main memory control circuit 13 and path 1022 before arriving at the main memory 14 to update the data in the main memory 14.

On the other hand, the store instruction sent to the path 1126 passes through the path 15 interconnecting all broadcast area caches before reaching all instruction processors 11 and 12. The store instruction which has entered the instruction processor 11 as the issuer of the store instruction is led through the path 1134 to the decoder 1112, which detects that it is a store instruction for the broadcast area; then it passes through the path 1135 and reaches the broadcast area cache 1103; the control circuit 1104 detects that the relevant address does not exist in the broadcast area cache 1103, so the broadcast area cache 1103 is not updated.

The store instruction which has entered the instruction processor 12, an instruction processor other than the instruction processor 11 as the issuer of the store instruction, is led through the path 1234 to the decoder 1212, which detects that it is a store instruction for the broadcast area. Then this store instruction passes through the path 1235 and reaches the broadcast area cache 1203; the control circuit 1204 detects that the relevant address does not exist in the broadcast area cache 1203. The control circuit 1204 does not update the broadcast area cache 1203. Further, the store instruction passes through the path 1236 and reaches the cache 1202. The cache 1202 detects that there is a line containing the relevant address in the cache 1202, so the line containing the relevant address in the cache 1202 is deleted.

Upon completion of the above-mentioned series of operations, the line containing the relevant address for the first issued store instruction is not registered in the cache 1202 and the broadcast area cache 1203.

Next, assuming that the CPU core 1101 of the instruction processor 11 issues a store instruction for the broadcast area, and that the relevant address is contained in both the cache 1202 and broadcast area cache 1203 of the non-issuer instruction processor 12, the system shown here runs in the following sequence.

The CPU core 1101 issues a store instruction. This store instruction passes through the path 1121, and is judged by the address decoder 1111 to be directed to the broadcast area. After knowing that it is a store instruction for the broadcast area, the address decoder 1111 sends this store instruction to the paths 1122 and 1126. The store instruction sent to the path 1122 reaches the cache 1102. Since the line containing the relevant address is not registered in the cache 1102, nothing occurs in the cache 1102. Then, the store instruction passes through the path 1123 and reaches the broadcast area cache 1103. The store instruction coming from the path 1123 causes nothing in the broadcast area cache 1103. The store instruction further passes through the paths 1124 and 1125, main memory control circuit 13 and path 1022 before arriving at the main memory 14 to update the data in the main memory 14.

On the other hand, the store instruction sent to the path 1126 passes through the path 15 interconnecting all broadcast area caches before reaching all instruction processors 11 and 12. The store instruction which has entered the instruction processor 11, as the issuer of the store instruction is led through the path 1134 to the decoder 1112, which detects that it is a store instruction for the broadcast area; then it passes through the path 1135 and reaches the broadcast area cache 1103; the control circuit 1104 detects that the relevant address does not exist in the broadcast area cache 1103, so the broadcast area cache 1103 is not updated.

The store instruction which has entered the instruction processor 12, an instruction processor other than the instruction processor 11 as the issuer of the store instruction, is led through the path 1234 to the decoder 1212, which detects that it is a store instruction for the broadcast area. Then this store instruction passes through the path 1235 and reaches the broadcast area cache 1203; the control circuit 1204 detects that the relevant address does exist in the broadcast area cache 1203. The control circuit 1204 updates the data for the relevant address in the broadcast area cache 1203. Further, the store instruction passes through the path 1236 and reaches the cache 1202. The cache 1202 detects that there is a line containing the relevant address in the cache 1202, so the line containing the relevant address in the cache 1202 is deleted.

Upon completion of the above-mentioned series of operations, the line containing the relevant address for the first issued store instruction is registered in the broadcast area cache 1203 as updated and not in the cache 1202.

Next, assuming that the instruction processor 11 sends data and the instruction processor 12 receives it, the system shown in FIG. 1 runs in the following sequence.

For the data to be sent to the instruction processor 12, the instruction processor 11 issues a store instruction for the broadcast area from the CPU core 1101 of the instruction processor 11. This store instruction passes through the path 1121, address decoder 1111, path 1126, path 15 and path 1234 before reaching the instruction processor 12. The store instruction which has reached the instruction processor 12 is led through the path 1234 to the address decoder 1212, which detects that it is a store instruction for the broadcast area. Then, it is sent through the path 1235 to the broadcast area cache 1203.

At the same time, the control circuit 1204 detects whether or not the line containing the relevant address for the store instruction has been registered in the broadcast area cache 1203; if yes, the relevant address in the broadcast area cache 1203 is updated. On the other hand, if the line containing the address for the store instruction has not been registered in the broadcast area cache 1203, the control circuit 1204 does not update the data in the broadcast area cache 1203.

The store instruction passes through the path 1236 and reaches the cache 1202. If the line containing the relevant address for the store instruction has been registered in the cache 1202, the cache 1202 deletes that line in it; on the other hand, if the line containing the relevant address for the store instruction has not been registered in it, the data in it is not updated.

After the instruction processor 11 has issued a store instruction for the broadcast area in order to send data to the instruction processor 12 and the above-mentioned series of operations has taken place, the instruction processor 11 and the instruction processor 12 are synchronized with each other.

Next, the instruction processor 12 issues a load instruction with regard to the relevant address for the store instruction issued by the instruction processor 11. This load instruction passes through the path 1221, address decoder 1211 and path 1222 and reaches the cache 1202. The cache 1202, in which the line containing the address for the load instruction has been deleted by the above-mentioned store instruction issued by the instruction processor 11, issues a block transfer instruction for the line containing the address for the load instruction.

This block transfer instruction passes through the path 1223 and reaches the broadcast area cache 1203. If the line containing the relevant address for the store instruction has been registered in the broadcast area cache 1203 at the time of issuance of the store instruction by the instruction processor 11, there is data updated by the store instruction in the broadcast area cache 1203, and thus the control circuit 1204 treats the line containing the relevant address in the broadcast area cache 1203 as reply data for the block transfer instruction issued by the cache 1202 and sends the reply data through the path 1232 to the cache 1202. The cache 1202 sends out the data for the address for the load instruction in this reply data through the path 1233 to the CPU core 1201.

On the other hand, if the line containing the address for the store instruction has not been registered in the broadcast area cache 1203 at the time of issuance of the store instruction by the instruction processor 11, the above-mentioned block transfer instruction is led through the path 1224, main memory control circuit 13 and path 1022 to the main memory 14, which then reads that line. The reply data thus read passes through the path 1023, main memory control circuit 13, path 1231, broadcast area cache 1203 and path 1232 and reaches the cache 1202. The cache 1202 sends out the data for the address for the load instruction in this reply data through the path 1233 to the CPU core 1201.

With the above-mentioned operations, data transfer from the instruction processor 11 to the instruction processor 12 is performed.

In the above-mentioned sequence, for inter-processor synchronization for data transfer from the instruction processor 11 to the instruction processor 12, if the data transfer is performed using a store instruction and a load instruction for the broadcast area, no waiting time to ensure coherency in synchronization is required. If the CPU core 1101 of the instruction processor 11 issues a store instruction, since the broadcast area caches 1103 and 1203 are caches which can be updated, coherency is guaranteed only by awaiting the completion of the store instruction.

Also in the above-mentioned sequence, the store instruction deletes the line containing the relevant address for the store instruction in the cache 1102 of the instruction processor 11 or the cache 1202 of the instruction processor 12, which means that coherency is guaranteed by the completion of the store instruction.

If the main memory control circuit 13 should be of the switch type and the path 15 interconnecting the broadcast area caches 1103 and 1203 should not exist, data would be transmitted through the switch type main memory control circuit 13 for the store instruction issued by one instruction processor (11) to be reflected in another instruction processor (12), which means that more time is required to guarantee coherency.

In the above-mentioned embodiment of the present invention, coherency is guaranteed with regard to the data in the broadcast area between the instruction processors 11 and 12 simply by synchronization of the instruction processors.

Next, an explanation is given as to how the control circuit 1104 for the broadcast area cache 1103 controls the broadcast area cache 1103.

Let's assume that a store instruction A for the broadcast area comes into the broadcast area cache 1103 from the path 1135. Here, it takes time from when the control circuit 1104 detects the existence of the line containing the address for the store instruction A in the broadcast area cache 1103, until the data in the broadcast area cache 1103 is actually updated. During the period from the detection of the existence of the line containing the address for the store instruction A in the broadcast area cache 1103 until actual updating of the data in the broadcast area cache 1103, if that line disappears from the broadcast area cache 1103 for another reason, operational trouble might occur. Hence, the control circuit 1104 works so that the line containing the address for the store instruction A cannot be deleted from the broadcast area cache 1103 for any reason before updating of the broadcast area cache 1103 is completed.

In case a new load instruction B for the broadcast area for which the address does not exist in the broadcast area cache 1103 comes into it from the path 1123, the control circuit 1104 deletes a line in the broadcast area cache 1103 as a preparation to newly register one of the lines in the broadcast area cache 1103 as the line to retain the result of access to the main memory by the load instruction B.

During the period from the detection of the existence of the line containing the address for the store instruction A in the broadcast area cache 1103 until actual updating of the data in the broadcast area cache 1103, the control circuit 1104 prevents the line containing the address for the store instruction A in the broadcast area cache 1103 from being newly registered as the line to retain the result of access to the main memory by a new load instruction B for the broadcast area, in order to ensure that the line cannot be deleted for any reason before updating of the broadcast area cache 1103 is completed.

Let's assume that a load instruction A for the broadcast area comes into the broadcast area cache 1103 from the path 1123. Here, it takes time from when the control circuit 1104 detects the existence of the line containing the address for the load instruction A in the broadcast area cache 1103, until the transfer of the data to the cache 1102 via the path 1136 is completed. During the period from the detection of the existence of the line containing the address for the load instruction A in the broadcast area cache 1103 until the completion of data transfer via the path 1136 to the cache 1102, if that line disappears from the broadcast area cache 1103 for another reason, operational trouble might occur. Hence, the control circuit 1104 works so that the line containing the address for the load instruction A cannot be deleted from the broadcast area cache 1103 for any reason before updating of the broadcast area cache 1103 is completed.

In case a new load instruction B for the broadcast area for which the address does not exist in the broadcast area cache 1103 comes Into it from the path 1123, the control circuit 1104 deletes a line in the broadcast area cache 1103 as a preparation to newly register one of the lines in the broadcast area cache 1103 as the line to retain the result of access to the main memory by the load instruction B.

During the period from the detection of the existence of the line containing the address for the load instruction A in the broadcast area cache 1103 until the completion of data transfer via the path 1136 to the cache 1102, the control circuit 1104 prevents the line containing the address for the load instruction A in the broadcast area cache 1103 from being newly registered as the line to retain the result of access to the main memory by another new load instruction B for the broadcast area, in order to ensure that the line cannot be deleted for any reason before updating of the broadcast area cache 1103 is completed.

Let's assume that a load instruction A for the broadcast area comes into the broadcast area cache 1103 from the path 1123 and that the control circuit 1104 detects the non-existence of the line containing the address for the load instruction A in the broadcast area cache 1103 and a line in the broadcast area cache 1103 is obtained to retain the result of data reading from the main memory by the load instruction A. Here, during the period from the obtainment of the line to retain the result of data reading from the main memory by the load instruction A, until the completion of writing into the broadcast area cache 1103 of the result of data reading from the main memory by the load instruction A, if that line disappears from the broadcast area cache 1103 for another reason, operational trouble might occur. Hence, the control circuit 1104 works so that the line containing the address for the load instruction A cannot be deleted from the broadcast area cache 1103 for any reason before data registration in the broadcast area cache 1103 is completed.

In case a new load Instruction B for the broadcast area for which the address does not exist in the broadcast area cache 1103 comes into it from the path 1123, the control circuit 1104 deletes a line in the broadcast area cache 1103 as a preparation to newly register one of the lines in the broadcast area cache 1103 as the line to retain the result of access to the main memory by the load instruction B.

During the period from the detection of the non-existence of the line containing the address for the load instruction A in the broadcast area cache 1103, through the obtainment of a line in the broadcast area cache 1103 to retain the result of data reading from the main memory by the load instruction A, until the completion of writing into the broadcast area cache 1103 of the result of data reading from the main memory by the load instruction A, the control circuit 1104 prevents the line obtained by the load instruction A in the broadcast area cache 1103 from being newly registered as the line to retain the result of access to the main memory by another new load instruction B, in order to ensure that the line cannot be deleted for any reason before updating of the broadcast area cache 1103 is completed.

Let's assume that a load instruction A for the broadcast area comes into the broadcast area cache 1103 from the path 1123. Here, it takes time from when the control circuit 1104 detects the non-existence of the line containing the address for the load instruction A in the broadcast area cache 1103 until a line in the broadcast area cache 1103 is newly obtained and finally the address information in the line registered in the broadcast area cache 1103 is updated. In this case, due to the non-existence of the line containing the address for the load instruction A in the broadcast area cache 1103, if a line is deleted to obtain a new line for the load instruction A and the line containing the address so far registered in that line is the line containing the address for a subsequent load instruction B, the load instruction B hits the line as rewritten by the load instruction A, resulting in incorrect reading.

A first method for avoiding the above-mentioned problem is to control the system as follows: if it takes time from when the control circuit 1104 detects the nonexistence of the line containing the address for the load instruction A in the broadcast area cache 1103 until a line in the broadcast area cache 1103 is newly obtained and finally the address information in the line registered in the broadcast area cache 1103 is updated, during the period until updating of the address information in the line registered in the broadcast area cache 1103, any subsequent load instruction is treated as having no registered line containing the address for it in the broadcast area cache 1103 and data is read not from the broadcast area cache 1103 but from the main memory 14.

A second method for avoiding the above-mentioned problem is to control the system as follows: if it takes time from when the control circuit 1104 detects the nonexistence of the line containing the address for the load instruction A in the broadcast area cache 1103 until a line in the broadcast area cache 1103 is newly obtained and finally the address information in the line registered in the broadcast area cache 1103 is updated, before updating of the address information in the line registered in the broadcast area cache 1103, the data which existed in the line obtained for the load instruction A before the obtainment is held only during the period from when the control circuit 1104 detects the non-existence of the line containing the address for the load instruction A in the broadcast area cache 1103 until a line in the broadcast area cache 1103 is newly obtained and finally the address information in the line registered in the broadcast area cache 1103 is updated, so that data can be read correctly by the subsequent load instruction B.

If one instruction processor (11) issues a store instruction A for the broadcast area and another instruction processor (12) issues a load instruction B for the broadcast area, and the address for the store instruction A and that for the load instruction B are the same, and the address for the load instruction B is not contained in the cache 1202 and broadcast area cache 1203 of the instruction processor 12, then both the store instruction A and the load instruction B reach the main memory 14.

In a computer system based on a multiprocessor having a main memory control circuit in which the order of arrival at the main memory of instructions for the main memory issued by another instruction processor (12) does not depend on the order of issuance of instructions by the instruction processor (11), if the store instruction A first arrives at the main memory 14 and then the load instruction B does, the load instruction B will read the result of updating of the data from the main memory 14 by the store instruction A.

It may be that the data read from the main memory 14 by the load instruction B will be stored in the broadcast area cache 1203 and cache 1202. In this case, it is ensured that the data stored in the main memory 14 is the same as the data stored in the broadcast area cache 1203 and the cache 1202 when the store instruction A and the load instruction B are completed.

If the load instruction B first arrives at the main memory 14 and then the store instruction A does, the load instruction B will read the previous data in the main memory 14, or data before updating by the store instruction A. It may be that the data read from the main memory 14 by the load instruction B will be stored in the broadcast area cache 1203 and cache 1202. In this case, when the store instruction A and load instruction B are completed, the main memory 14 reflects the result of the store instruction A but the data stored in the broadcast area cache 1203 and the cache 1202 does not reflect it.

One method for avoiding inconsistency between the data in the broadcast area cache 1203 and cache 1202 and that in the main memory 14 is to control the system as follows: if the result of a store instruction for the broadcast area may not be reflected due to a load instruction for the broadcast area issued by an instruction processor (12), even though the load instruction is directed to the broadcast area, it is not registered in the broadcast area cache 1203.

Also, if there is a transition from a program under execution to another program due to an interruption or OS multitask operation, the data concerned can be stored by controlling the system as follows.

Let's assume that the program A under execution is handling data transfer between instruction processors using part of the broadcast area. If there is a transition to another program B, an address in the broadcast area different from the one used by the program A is used so that the program B can handle data transfer using the broadcast area without destroying the data used by the program A.

Later, the operation under the program A can be resumed from the point where It was interrupted by the program B, again by referring to the address in the broadcast area previously used by the program A. Furthermore, when there is a transition to a program C which requires a broader main memory area than the existing broadcast area, a broader broadcast area can be used for data transfer between the instruction processors by redefining the broadcast area as a region of the main memory.

Next, how the control circuit 1104 for the broadcast area cache 1103 works is explained by reference to FIG. 2.

Let's assume that the instruction processor 11 issues a load instruction and that the line containing the relevant address does not exist in the cache but exists in the broadcast area cache 1103. Here, the load instruction issued by the instruction processor 11 enters the path 251 inside the control circuit 1104 for the broadcast area cache 1103. In the control circuit 1104, an address comparator 201 compares address information 211 for the line whose validity is confirmed by validity check flag 212 in control data 210, 220, 230 and 240 which correspond to lines in the broadcast area cache 1103, and the address information for the load instruction to identify the line containing the address for the load instruction.

Then, the reply data return check circuit 204 in the control circuit 1104 decides whether the data from the line concerned may be returned or not. In other words, if load flag 212, store completion standby flag 215 or reply flag 214 in the relevant line is ON, the control circuit 1104 does not return reply data for the load instruction from the broadcast area cache 1103, but sends the load instruction to the main memory 14 and transfers the data from the main memory as reply data for the load instruction to the cache 1102 and the CPU core 1101.

In addition, if load flag 212, store completion standby flag 215 and reply flag 214 in the line concerned are all OFF, the control circuit 1104 makes the reply data return check circuit 204 admit return of the reply data from the broadcast area cache 1103, turns ON the reply flag 214 in the line concerned and starts to return the line from the broadcast area cache 1103 as reply data through the path 206.

Upon completion of the return of the data in the line from the broadcast area cache 1103, the reply flag in the line turns OFF.

Next, let's assume that the instruction processor 11 issues a load instruction and that the line containing the relevant address does not exist in the cache and the broadcast area cache 1103. Here, the load instruction issued by the instruction processor 11 enters the path 251 inside the control circuit 1104 for the broadcast area cache 1103. In the control circuit 1104, the address comparator 201 compares address information 211 for the line whose validity is confirmed by line validity check flag 212 in control data 210, 220, 230 and 240 which correspond to lines in the broadcast area cache 1103, and the address information for the load instruction, and finds that the address information for the load instruction is not identical to the address information in any valid line.

Since the line containing the address for the load instruction does not exist in the broadcast area cache 1103, the control circuit 1104 sends the load instruction directly to the main memory 14. At the same time, the broadcast area cache line replace control circuit 203 in the control circuit 1104 decides which one among replaceable lines to be replaced.

One method for selecting the line to be replaced may be the use of LRU. The control circuit 1104 allows replacement of a line whose load flag 213, reply flag 214 or store completion standby flag is ON to prevent replacement of a line which might affect the control.

Having selected the line to be replaced, the control circuit 1104 replaces the address information 211 for the line concerned with the address information for the load instruction and sets the validity check flag 212 to “valid” and turns ON the load flag 213 to instruct the broadcast area cache 1103 through the path 206 to register reply data into the line.

Then, when the reply data for the load instruction is sent back from the main memory 14 to the broadcast area cache 1103, the control circuit 1104 sends the reply data to the cache 1102 and the CPU core 1101, and at the same time writes it in the relevant line in the broadcast area cache 1103.

When all necessary reply data becomes available in the relevant line in the broadcast area cache 1103, the load flag in the line is turned OFF.

If all lines are unreplaceable, it is impossible to obtain a required line in the broadcast area cache 1103 by means of a load instruction; therefore the control circuit 1104 does not register a line containing the address for the load instruction, in the broadcast area cache 1103. Here, the load instruction works regardless of the broadcast area cache 1103: reply data is read from the main memory 14 and led through the broadcast area cache 1103 to the cache 1102 and the CPU core 1101.

Next, let's assume that a store instruction for the broadcast area reaches the broadcast area cache 1103 through the path 1135 interconnecting the broadcast area caches and the line containing the relevant address exists in the broadcast area cache 1103. In this case, the store instruction enters the path 252 inside the control circuit 1104 for the broadcast area cache 1103. In the control circuit 1104, the address comparator 202 compares address information 211 for the line whose validity is confirmed by line validity check flag 212 in control data 210, 220, 230 and 240 which correspond to lines in the broadcast area cache 1103, and the address information for the store instruction and identifies the line containing the address for the store instruction.

The control circuit 1104 turns ON the store completion standby flag 215 and instructs, through the path 206, the broadcast area cache 1103 to have the store data reflected in the relevant line. Upon completion of updating of the data in the line in the broadcast area cache 1103, the store completion standby flag for the line is turned OFF.

If the load flag for the line is ON upon arrival of the store instruction, all reply data for the load instruction directed to the main memory 14 is not back in the broadcast area cache 1103, and thus the content of the line may not be identical to the data indicated by the address information for the broadcast area cache 1103 in the main memory 14. Therefore, if data given by the store instruction is written in the broadcast area cache 1103, it might be overwritten by the reply data for the load instruction later.

One method for avoiding this is to prevent the reply data for the load instruction from overwriting the data updated by the store instruction. Another method is to invalidate the relevant line in the broadcast area cache 1103 upon arrival of the store instruction for the address contained in the line whose load flag is ON.

Even if the line in the broadcast area cache 1103 is invalidated, the reply data returning from the main memory 14 to the broadcast area cache 1103 is directly sent to the cache 1102 and the CPU core 1101 as reply data for the load instruction, so the load instruction is properly completed. Also, even if the line in the broadcast area cache 1103 is invalidated by a store instruction, the store instruction has been sent to the main memory 14 as well, so the main memory 14 can read the new data by means of a load instruction issued later to reflect the result of the store instruction.

Next, let's assume that a store instruction for the broadcast area reaches the broadcast area cache 1103 through the path 1135 interconnecting the broadcast area caches and the line containing the relevant address does not exist in the broadcast area cache 1103. In this case, the store instruction enters the path 252 inside the control circuit 1104 for the broadcast area cache 1103. In the control circuit 1104, the address comparator 202 compares address information 211 for the line whose validity is confirmed by line validity check flag 212, available in control data 210, 220, 230 and 240 which correspond to lines in the broadcast area cache 1103, and the address information for the store instruction and detects the non-existence of the line containing the address for the store instruction.

At this moment, the store instruction is found invalid for the broadcast area cache 1103 and thus annulled.

An alternative method is to use a store instruction to register the line into the broadcast area cache 1103.

In this method, if the line containing the address for the store instruction which has arrived at the broadcast area cache 1103 through the path 1135 does not exist in the broadcast area cache 1103, one of the lines in the broadcast area cache 1103 is newly registered as a line containing the address for the store instruction and data given by the store instruction is written there. The control circuit 1104 controls the system as follows in order to read from the main memory 14, data in the line containing the address for the store instruction, other than the data written by the store instruction: a load instruction to read from the main memory 14 data in the line containing the address for the store instruction is generated in the broadcast area cache 1103 and sent to the path 1124; when the data comes back to the broadcast area cache 1103 after passing through the main memory control circuit 13, path 1022, main memory 14, path 1023, main memory control circuit 13 and path 1131, data other then the data previously written by the store instruction is written in the relevant line in the broadcast area cache 1103.

For data transfer between instruction processors, the data-sending instruction processor must execute a store instruction, so if a registration into the broadcast area cache 1103 is made at the time of issuance of the store instruction, it can make the registration earlier than the data-receiving instruction processor issues a first load instruction. This further reduces the time required for data transfer between the instruction processors.

In the above-mentioned method for making a registration into the broadcast area cache 1103 by means of a store instruction, the line containing the address for the store instruction may also be registered in a broadcast area cache 1103 of the instruction processor which is not involved in the data transmission/reception.

One method for avoiding this is as follows: the combination of instruction processors involved in data transmission/reception is predetermined so that only the broadcast area caches 1103 in the predetermined instruction processors can, upon issuance of a store instruction, register the line containing the address for the store instruction into their broadcast area caches 1103.

According to one aspect of the above-mentioned embodiment of the present invention, in a multiprocessor system which can register data from the main memory into the cache memory, a function to designate an arbitrary range of consecutive addresses in the main memory as a special region and special cache memories to register only the data in the special region are provided so that the content of the special cache memories cannot be affected by access to a region other than the special region.

Also, according to another aspect of the above-mentioned embodiment of the present invention, when each processor has an independent cache memory and coherency between the cache memories is controlled, if the data registered in the special cache memory of one processor is subjected to updating by another processor, the registered data in the special cache memory can be updated without invalidating it and thus quicker data transfer between instruction processors can be achieved.

According to a further aspect of the above-mentioned embodiment of the present invention, in a multiprocessor system as mentioned above which is composed of three or more processors, it has a broadcasting means to send the same data to all the processors at a time so that, if the same data is registered in the cache memories of two or more processors and is subjected to updating by another processor, the updated data is sent to all the processors by the broadcasting means and the registered data in the special cache memories is updated. This eliminates the need for any special operation to guarantee coherency, leading to quicker data transfer between the instruction processors.

According to another aspect of the above-mentioned embodiment of the present invention, in a multiprocessor system as mentioned above which is composed of three or more processors and in which each processor is connected with the main memory by a switch and has an independent cache memory capable of registering data from the main memory and hardware to control coherency between the cache memories is provided, apart from the switch for connection between each processor and main memory, a broadcasting means to send the same data to all processors is provided, so that by updating the registered data in the special cache memories is updated, the need for any special operation to guarantee coherency is eliminated, leading to quicker data transfer between instruction processors.

While the invention has been particularly shown and described with reference to preferred embodiments thereof, it will be understood by those skilled in the art that the foregoing and other changes in form and details can be made therein without departing from the spirit and scope of the invention.

The preceding has been a description of the preferred embodiment of the invention. It will be appreciated that deviations and modifications can be made without departing from the scope of the invention, which is defined by the appended claims.

What is claimed is:

1. A multiprocessor system having a plurality of instruction processors and a main memory, the multiprocessor system comprising:
a first cache memory to register data from the main memory;
a means to designate an arbitrary range of consecutive addresses in the main memory as a specific region; and
a second cache memory to register only data in the specific region of the main memory.

2. The multiprocessor system according to claim 1, wherein the first and second cache memories being provided with each of the instruction processors constituting the multiprocessor, and the multiprocessor system comprising:
a means to control coherency between the first cache memories; and
a means to, when the data registered in the second cache memory of one instruction processor is subjected to updating by another instruction processor, update the registered data in the second cache memory without invalidating it.

3. The multiprocessor system according to claim 2, further having a broadcasting means to send the same data to all processors,
wherein the same data is registered in the second cache memory of each processor and, when the same data in the second cache memories is subjected to updating operation by a processor, said broadcasting means sends the updated data to all other processors and the processors each update the same registered data in their second cache memories.

4. The multiprocessor system according to claim 3, wherein the plurality of instruction processors is connected with the main memory by a switch.

5. The multiprocessor system according to claim 1, further having a broadcasting means to send the same data to all processors at a time, wherein the plurality of instruction processors is connected with the main memory by a switch.

6. A multiprocessor system comprising a plurality of instruction processors and a main memory, wherein the instruction processors define part of the main memory as a broadcast area and an instruction processor being about to send data, among the instruction processors, designates a main memory address in the broadcast area and sends the data to the main memory.

7. The multiprocessor system according to claim 6, further having a broadcast area cash for the broadcast area only,
wherein the instruction processors use the broadcast area caches for data transfer between the instruction processors.

8. The multiprocessor system according to claim 7, wherein the instruction processors send data to the broadcast area cache corresponding to a data-receiving instruction processor.

9. The multiprocessor system according to claim 7, wherein, when the broadcast area cache corresponding to a data-receiving instruction processor contains the address for the data to be sent/received, the data-receiving instruction processor receives the data from the broadcast area cache.

10. The multiprocessor system according to claim 7, wherein, when the broadcast area cache corresponding to a data-receiving instruction processor does not contain the address for the data to be sent/received, the data-receiving instruction processor receives the data from the main memory.

11. The multiprocessor system according to claim 7, wherein, when the broadcast area cache corresponding to a data-receiving instruction processor does not contain the address for the data to be sent/received, the data for the address is cached in the broadcast area cache beforehand.

12. The multiprocessor system according to claim 7, wherein the plurality of instruction processors is connected with the main memory by a switch.

13. A data transmitting method used in a multiprocessor system having a plurality of instruction processors and a main memory, said data transmitting method comprising the steps of:
defining part of the main memory as a broadcast area;
transferring data between the instruction processors by using a broadcast area cache for data of the broadcast area;
sending the data to the main memory by designating an address of main memory in the broadcast area; and
transmitting the data to the broadcast area cache corresponding to an instruction processor to receive the data.

14. The data transmitting method according to claim 13, further comprising;
receiving data to be received from the broadcast area cache when the broadcast area cache corresponding to the data-receiving instruction processor contains the address for the data to be sent/received.

15. The data transmitting method according to claim 13, further comprising;
receiving data to be received from the main memory when the broadcast area cache corresponding to the data-receiving instruction processor does not contain the address for the data to be sent/received.

16. The data transmitting method according to claim 13, wherein the data for the address is cached in the broadcast area cache beforehand when the broadcast area cache corresponding to the data-receiving instruction processor does not contain the address for the data to be sent/received.

17. The data transmitting method according to claim 13, further comprising;
detecting to update a broadcast area cache in synchronization between the instruction processors.
